(19) United States
(12) Patent Application Publication
(10) Pub. No.: US 2021/0298345 A1
(43) Pub. Date: Sep. 30, 2021

(54) FOOD PRODUCT

(71) Applicant: BYRON FOOD SCIENCE PTY LIMITED, Bowral, New South Wales (AU)

(72) Inventors: Deborah LEWIS, Bowral (AU); David LEWIS, Bowral (AU)

(73) Assignee: BYRON FOOD SCIENCE PTY LIMITED, Bowral (AU)

(21) Appl. No.: 16/346,504

(22) PCT Filed: Oct. 31, 2017
(86) PCT No.: PCT/AU2017/051198

§ 371 Date: Apr. 30, 2019

(30) Foreign Application Priority Data
Oct. 31, 2016 (AU) 2016904432

(51) Int. Cl. A23P 30/40; A23G 9/46; A23C 9/154; A23G 1/52; A23L 17/00; A23L 31/00; A23L 29/212; A23L 29/00; A23G 9/34; A23G 9/32; A23G 1/40; A23G 1/32; A23C 9/152

(52) U.S. Cl. CPC A23P 30/40; A23V 2002/00; A23C 9/1544; A23G 1/52; A23L 17/00; A23L 31/00; A23L 29/212; A23L 29/035; A23L 29/015; A23G 9/34; A23G 9/325; A23G 1/40; A23G 1/325; A23C 9/1522; A23G 9/46

(57) ABSTRACT

Disclosed herein is a composition for forming an aerated ready-to-eat food product quiescently and in ambient environmental conditions. The composition comprises a matrix forming system which is capable of forming a matrix defining a structure of the food product at ambient environmental conditions upon exposure to a liquid. The composition also comprises an aerating system comprising an acidulant which is capable of acidulating at ambient environmental conditions at a rate that is similar to a rate at which the matrix is formed upon exposure to a liquid, and an alkali which is capable of reacting with the acidulant to form an aerating gas.

### TECHNICAL FIELD

The present invention relates to food products and to compositions for forming food products. In particular, the present invention relates to aerated ready-to-eat food products and to compositions for forming aerated ready-to-eat food products.

### BACKGROUND ART

The food technology industry continuously seeks to produce new food products having properties such as texture, taste and mouthfeel that are pleasing to consumers. Other features which might enhance the appeal of a food product include its storage stability, nutrition profile and the effort required by the consumer to prepare the food product.

It would be advantageous to provide novel food products, especially those which can be prepared relatively easily by consumers.

### SUMMARY OF INVENTION

In a first aspect, the present invention provides a composition for forming an aerated ready-to-eat food product quiescently and in ambient environmental conditions. The composition comprises a matrix forming system which is capable of forming a matrix defining a structure of the food product at ambient environmental conditions upon exposure to a liquid. The composition also comprises an aerating system comprising an acidulant which is capable of acidulating at ambient environmental conditions at a rate that is similar to a rate at which the matrix is formed upon exposure to a liquid, and an alkali which is capable of reacting with the acidulant to form an aerating gas.

The inventors believe that aerated ready-to-eat food products formed from the composition of the present invention are unique amongst food products that can be formed under ambient environmental conditions (i.e. without heating or cooling) and quiescently (i.e. without using significant amounts of mechanical energy to stir or whip the composition during formation of the food product). The composition of the present invention can surprisingly be used to produce an aerated ready-to-eat food product simply by admixture with a liquid under ambient environmental conditions (e.g. on a kitchen bench top), with the interactions between the matrix forming system and aerating system during formation of the food product imparting textural and structural properties to the resultant food product. Food products in accordance with the present invention are distinct from cakes, pancakes, scones and the like, because these require the application of heat (e.g. steaming, baking, microwaving or panfrying) to achieve lightness or increased bulk and to provide the characteristics for edibility. Food products in accordance with the present invention are distinct from ice cream, sorbet, mousses, savoury dips and spreads and the like, because these require the application of significant amounts of mechanical energy (e.g. vigorous mixing for a significant period of time) to achieve lightness or increased bulk to provide the characteristics for edibility.

The process via which the aerated ready-to-eat food product is formed from the composition of the present invention is typically relatively straightforward and not too time consuming. The composition is therefore likely to appeal to people who do not necessarily possess a high degree of culinary skill or potentially expensive kitchen appliances (although it could equally be used in professional kitchens to prepare components of a meal or dessert). Further, as the composition may be provided as a dry mix of ingredients (or ingredients that are otherwise shelf-stable), it can be stored for relatively long periods of time without risk of spoilage.

In some embodiments, the liquid is selected from the group consisting of: full-cream milk, low fat milk, skim milk, flavoured milk, soy milk, nut milk, rice milk, oat milk, dairy cream, vegetable stock, vegetable juice, meat stock, fish stock, coconut water, coconut milk, coconut cream, water and combinations thereof. In some embodiments, the liquid mixed with the composition is cold (e.g. just taken out of a refrigerator).

In some embodiments, the matrix forming system may comprise a pre-gelatinised starch, a pre-gelatinised starch-containing flour or a mixture thereof. In some embodiments, the matrix forming system may also comprise one or more stabilisers. In some embodiments, the matrix forming system may also comprise one or more moisture holding agents.

In some embodiments, the aerating system may comprise an acidulant comprising an acid, an acid salt or an acid lactone that acidulates upon exposure to the liquid. In some embodiments, the aerating system may comprise an alkali comprising a carbonate or bicarbonate salt.

In some embodiments, the composition may further comprise one or more additional components, such as a sweetener, a source of protein, a source of fat, an emulsifier, a flavourant and a colourant. In some embodiments, the composition may further comprise one or more additional nutrients, vitamins, minerals, dried microbial cultures or the like. In some embodiments, the composition may further comprise other food-stuffs (e.g. fruit, meat, nuts, confectionary, etc.) for suspension within the resultant food product.

In a second aspect, the present invention provides a composition comprising a matrix forming system and an aerating system comprising an acidulant and an alkali. In ambient environmental conditions and upon exposure to a liquid, the matrix forming system forms a matrix defining a structure of the food product, and the acidulant acidulates at a rate that is similar to a rate at which the matrix is formed and progressively reacts with the alkali to form an aerating gas.

The components in some embodiments of the second aspect of the present invention may be the same as is described herein in relation to the first aspect of the present invention.

In a third aspect, the present invention provides an aerated ready-to-eat food product which is produced by mixing the composition of the first or second aspect of the present invention with a liquid.

In a fourth aspect, the present invention provides a method for forming an aerated ready-to-eat food product. The method comprises admixing a liquid with a mixture comprising a matrix forming system and an aerating system and quiescently maintaining the resultant mixture in ambient environmental conditions. The matrix forming system forms a matrix defining a structure of the food product upon exposure to the liquid. The aerating system comprises an acidulant which, upon exposure to the liquid, acidulates at a rate that is similar to a rate at which the matrix is formed and an alkali capable of reacting with the acidulant to form an aerating gas. In some embodiments, the mixture may subsequently be chilled or frozen.

### DESCRIPTION OF EMBODIMENTS

The present invention provides compositions for forming aerated ready-to-eat food products quiescently and under ambient environmental conditions. The aerated ready-to-eat food product may be sweet or savoury and served frozen, chilled or at ambient temperatures.

In a first aspect, the composition comprises a matrix forming system which is capable of forming a matrix defining a structure of the food product in ambient environmental conditions upon exposure to a liquid. The composition also comprises an aerating system comprising an acidulant which is capable of acidulating at ambient environmental conditions at a rate that is similar to a rate at which the matrix is formed upon exposure to a liquid and an alkali which is capable of reacting with the acidulant to form an aerating gas.

In a second aspect, the composition comprises a matrix forming system and an aerating system comprising an acidulant and an alkali. At ambient environmental conditions and upon exposure to a liquid, the matrix forming system forms a matrix defining a structure of the food product and the acidulant acidulates at a rate that is similar to a rate at which the matrix is formed and progressively reacts with the alkali to form an aerating gas.

As used herein, the phrase “aerated” is to be understood to mean that once the composition and liquid have been admixed and allowed to stand quiescently as directed, the resultant ready-to-eat food product will become interspersed by a multitude of gas bubbles distributed substantially homogeneously throughout the stable matrix, thus giving the food product a lightness due to its reduced bulk density and increased volume. The volume of the mixture may increase by up to about two times from that of the initial mixture of the composition and liquid (with a corresponding decrease in bulk density) during formation of the aerated ready-to-eat food product.

As used herein, the phrase “ready-to-eat food product” is to be understood to mean a food product that is in an appropriate state for consumption by a consumer without requiring any further processing (e.g. baking, steaming, microwaving, frying or the like).

As used herein, the term “quiescently” is to be understood to mean that (once the components of the composition and liquid have been admixed) the mixture is allowed to stand without disturbance or the application of any further mechanical action such as mixing, whipping or other turbulence.

As used herein, the phrase “ambient temperatures” is to be understood to mean the environmental temperatures that would be encountered on the kitchen benchtops (for example) of users who wanted to form the aerated ready-to-eat food product from the compositions disclosed herein.

As used herein, the phrase “ambient environmental conditions” is to be understood to mean the environmental conditions (temperature, humidity and pressure probably being the most relevant) that would be encountered on the kitchen benchtops (for example) of users who wanted to form the aerated ready-to-eat food product from the compositions disclosed herein.

The compositions of the present invention include at least a matrix forming system and an aerating system comprising an acidulant and an alkali. These components must be suitable for forming aerated ready-to-eat food products quiescently and at ambient environmental conditions in accordance with the present disclosure (e.g. by leaving the admixed components and liquid to stand on a kitchen bench to form the food product). Thus, the food products of the present invention are formable without the need for heating/cooling and/or vigorous mechanical agitation, which characterise prior art processes for forming ice creams, mousses, dips, baked goods, etc.

The aerated ready-to-eat food product in accordance with the present invention is a food product having what the inventors consider to be unique properties for food products that are not cooked or mechanically vigorously mixed during their formation. In particular, the aerated ready-to-eat food product formed using the composition of the present invention has a texture and structure which the inventors believe is unique (for food products which can be formed quiescently and under ambient conditions). The interactions between the matrix forming and aerating systems during formation of the food product result in textural and structural properties not found in other food products that can be formed quiescently and at ambient temperatures.

In some embodiments, the aerated ready-to-eat food product may be a dessert product. The inventors have discovered that the present invention can result in aerated ready-to-eat dessert products having surprising properties. For example, the compositions of the present invention can produce frozen desserts of many types in the hands of the user, including frozen desserts bearing similarities to ice cream, gelato and the like, but which may be thawed without melting and served chilled or at ambient temperatures. Such dessert products will be described in further detail below.

At a minimum, the compositions of the present invention comprise the matrix forming system and the aerating system (i.e. the acidulant and alkali). Typically, these components are provided in a form in which they are suitable for admixing (in an amount measured by weight or volume) with a liquid (in an amount measured by weight or volume) in a container. The matrix formation and aeration reactions then simultaneously occur within the container and the resultant increased volume, aerated food product may be served directly from the container. Alternatively, the mixture can be portioned out into serving containers before, during or after aeration is complete. As will be appreciated, such a composition is in the form of a “ready-to-mix” composition, which can be used to produce an aerated ready-to-eat food product simply by admixture with a liquid.

Indeed, the process via which the aerated ready-to-eat food product is formed from the composition is relatively straightforward, involves only a small time commitment and does not require specialised equipment. The composition is thus likely to appeal to people who do not necessarily possess a high degree of culinary skill or potentially expensive kitchen appliances (e.g. ice cream makers or other mechanical mixers), or who only have short periods of time available for preparing food.

As noted above, the components of the composition of the present invention are typically provided in powder form, preferably as a fine and uniform mix suitable to be admixed (in an amount measured by weight or volume) with the liquid (in an amount measured by weight or volume). As will be appreciated, compositions in powder form can often be stored for relatively long periods of time without risk of spoilage.

It is to be appreciated, however, that one or more of the components of the composition of the present invention could be provided in non-powder form. For example, in some embodiments, one or more of the components may be provided in liquid form and may, for example, be provided in a sealed sachet for the user to open and admix with the other components when forming the food product. It is also possible to include the required volume of the liquid packed in a separate pouch or can, provided that the liquid can be provided in a shelf-stable format (e.g. preserved by UHT treatment or pasteurisation). The proportions of the components of the compositions of the present invention are described below in the context of substantially dry ingredients. It would be within the ability of a person skilled in the art to adapt these values if non-dry components were to be used.

The composition typically comprises a mixture of the components described herein in amounts sufficient to form the aerated ready-to-eat food product upon addition of a predefined weight or volume of liquid. The components of the composition may, for example, be packaged into unit quantities (e.g. in a thoroughly mixed form) to make, for example, 1 litre of food product, or into larger packs to make larger quantities as for food service and industrial usage. Packaging of dry mix components should ideally be substantially moisture-proof and of low oxygen transmission in order to provide the longest possible shelf-life. In some circumstances (and depending on the components), it may be advantageous for packages containing dry mix components to be nitrogen-flushed to preserve the quality of the components. Simple instructions could be printed on the side of a package containing the composition, and larger packages could be resealable for reuse multiple times.

### Matrix Forming System

The composition for forming the aerated ready-to-eat food product has a matrix forming system which is capable of forming a matrix defining a structure of the food product at ambient environmental conditions upon exposure to a liquid. The matrix forming system provides the important function of increasing the viscosity of the mixture of the composition and liquid as rapidly as possible after liquid addition, which enables a maximum amount of the aeration gas released by the aerating system to be captured and entrained within the forming matrix once the liquid and the composition have been mixed. The matrix forming system also provides the aeration-retention and form-retaining character of the food product after its formation. Typically, the matrix forming system is such that the matrix, once formed, is irreversibly set such that the food product does not readily (e.g. under ambient conditions) break down (e.g. by syneresis or melting).

The matrix forming system may comprise any agent (or combination of agents) which are permissible food additives and are capable of providing the required function. It is within the ability of persons skilled in the art to select matrix forming agents suitable for use in the present invention, with routine and straightforward experiments able to be carried out in accordance with the teachings contained herein to ascertain whether or not a specific matrix agent(s) is suitable. If the resultant food product has the characteristics of the aerated ready-to-eat food product described herein (which can readily be ascertained by observing and tasting the food product), then the matrix agent(s) are suitable.

The inventors have found that pre-gelatinised starches and pre-gelatinised-starch-containing flours are examples of matrix forming agents which can advantageously both retain the gas produced by the aeration system and form a set product without requiring any heat or other form of mechanical energy. Accordingly, in some embodiments, the matrix forming system may comprise a pre-gelatinised starch (preferably a pre-gelatinised dry starch), a pre-gelatinised-starch-containing flour or a mixture thereof.

The matrix forming system may, for example, comprise pre-gelatinised starch preparations such as those prepared from modified or natural waxy maize, tapioca or other pre-gelatinised starches such as those prepared from potato, rice, barley or wheat. The matrix forming system may, for example, comprise pre-gelatinised-starch-containing flours such as pre-gelatinised wheat, corn, potato, rice or tapioca flours. The matrix forming system may comprise combinations of two or more of these agents.

The proportion of the matrix forming agent(s) in the composition will depend on a number of factors, including the nature of the food product, presence of other components, its intended density, mouth feel, texture, stability and nutritional qualities. In general, the lower the proportion of the matrix forming agent(s) in the composition, the softer the product. In some embodiments, the matrix forming agent will comprise between about 5% and 90% by weight of the total composition. In some embodiments, the matrix forming agent will comprise between about 10% and 90%, between about 15% and 75%, between about 20% and 70%, between about 30% and 60%, or between about 40% and 50% by weight of the total composition. In some embodiments, the matrix forming agent will comprise about 5%, 10%, 15%, 20%, 25%, 30%, 35%, 40%, 45%, 50%, 55%, 60%, 65%, 70%, 75%, 80%, 85% or 90% by weight of the total composition.

In some embodiments, beneficial properties may be imparted to the resultant food product if the matrix forming system also includes one or more stabilisers or moisture holding agents. Stabilisers can enhance the gas holding properties and help to stabilise the aerated matrix, especially over extended periods of time. Moisture holding agents and stabilisers may also, for example, help reduce or prevent undesirable events such as syneresis, crystal formation or skin formation. Suitable stabilisers include, for example, cellulose derivatives (e.g. methylcelluloses (CM), carboxymethylcellulose (CMC), hydroxypropylcellulose (HPC) and their salts or combinations), other polysaccharides (e.g. gallactomannans and dextrins) and hydrocolloids. Suitable moisture holding agents include, for example, guar gum, gellan gum, alginates, pectin, locust bean gum, xanthan gum, carrageenan, konjac, seaweed extract, gelatin, agar and combinations thereof.

When present, the level of addition of moisture holding agent(s) or stabiliser(s) may, for example, be between about 0.1% and about 10% by weight of the total composition.

The matrix forming system comprises a matrix forming agent or agents which is/are capable of forming a matrix defining a structure of the food product at ambient environmental conditions and upon exposure to a liquid. Any aqueous liquid fit for human consumption may be added to the compositions of the present invention to prepare the aerated ready-to-eat food product. The liquid may, for example be full-cream milk, low fat milk, skim milk, flavoured milk, soy milk, nut milk, rice milk, oat milk, dairy cream, vegetable stock, vegetable juice, meat stock, fish stock, coconut water, coconut milk, coconut cream, water and combinations thereof. Optionally, the liquid may also include liquid dairy cream or other high-fat cream product such as coconut cream if it is required to produce a food product of higher fat content.

In some embodiments, the liquid mixed with the composition may be provided cold (e.g. taken directly from a refrigerator and having a temperature of between 2-8° C. or about 4° C.). Using a cold liquid in this manner may help to slow down the rates at which the matrix forming and aerating systems react during the mixing stage (particularly the rate of acidulation and production of the aerating gas), which may be beneficial in some circumstances (e.g. when the ambient environmental conditions are relatively hot). If the aeration system were to react too quickly, the aerating gas (or a significant proportion thereof) formed might escape before the matrix forms to an extent where the gas becomes entrapped and interspersed therethrough. In other embodiments (e.g. in colder climates or where the composition includes less reactive acidulants), however, liquid at ambient temperature (e.g. water taken from a tap) may be suitable.

As noted above, ambient environmental conditions, in the context of the present invention, are the environmental conditions (especially the temperature) that would be encountered by users who wanted to form the aerated ready-to-eat food product from the compositions disclosed herein. Typically, the composition would be mixed with the liquid (e.g. a cold liquid) at an ambient temperature of between about 4° C. and about 25° C., with the mixture thereafter being quiescently kept on the kitchen bench (for example) at room temperature (e.g. if the food product is for immediate consumption) or, as described below, in a refrigerator (e.g. at about 4° C.). Alternatively, after the mixture has been quiescently kept on the kitchen bench or in a refrigerator for about 10 to about 60 minutes (or more), it may then be stored in a freezer at about −18° C. (e.g. in circumstances where the food product is intended to be served cold or frozen, or stored for a relatively long period of time) and whilst matrix formation continues. The matrix forming system must be capable of forming a matrix defining a structure of the food product under any possible ambient conditions (e.g. between about 4° C. and about 45° C.), even though the rate of formation will likely slow down as the temperature decreases. Similarly, the acidulant must be capable of acidulating at a rate that is similar to a rate at which the matrix is formed under any such ambient conditions (e.g. between about 4° C. and about 45° C.), even though the rate of formation will likely slow down as the temperature decreases.

The conditions under which the food product of the present invention is formed can be adapted as required in order to best utilise specific matrix forming and aerating systems (etc.) using no more than routine experimentation.

### Aerating System

The composition for forming an aerated ready-to-eat food product also has an aerating system comprising an acidulant which is capable of acidulating at ambient environmental conditions at a rate that is similar to the rate at which the matrix is formed upon exposure to a liquid, and an alkali which is capable of reacting with the acidulant to form an aerating gas.

The acidulant may be any acidulant which is a permitted food additive and which is capable of acidulating at a controlled rate under ambient environmental conditions and upon exposure to the liquid. The acidulant may, for example, comprise an acid, an acid salt or an acid lactone (or a combination thereof) that acidulates upon exposure to the liquid. Specific acidulants (which may be used alone or in combination) include cream of tartar, acid calcium phosphates, glucono delta lactone, tartaric acid, adipic acid, fumaric acid, malic acid and citric acid.

The acidulant acidulates at a rate that is similar to the rate at which the matrix is formed at ambient environmental conditions and upon exposure to the liquid. As will be appreciated, it is necessary for the acidulant to acidulate in order for it to be able to react with the alkali to form the aerating gas. However, if the acidulant were to acidulate immediately upon contact with the liquid, much or all of the gas produced in its reaction with the alkali may not be incorporated into the matrix of the food product being formed (probably resulting in a sub-optimal or even an un-aerated food product). Further, too rapid an increase in acidity might have undesirable effects such as curdling of protein components or denaturing of other components in the composition. On the other hand, if the acidulant acidulates too slowly, then the matrix forming system might form the matrix before a sufficient amount of gas is produced, possibly resulting in the formation of a sub-optimal or even an un-aerated food product, or a food product containing unreacted acidulant and alkali (which may impart an undesirable taste or mouth feel to the resultant food product). Routine trials and experimentation using the techniques disclosed herein can readily be performed by a person skilled in the art to determine whether the components of any given aerating system will acidulate at an appropriate rate and hence produce an aerated ready-to-eat food product in accordance with the present invention.

It is not necessary for the acidulant to acidulate at exactly the same rate at which the matrix is formed, nor that the acidulant acidulates for the entire time that the matrix forming agent is forming the matrix (and vice versa). It is important, however, that the aerating gas be produced at around the same time as the matrix is being formed, so that the resultant food product has a substantially consistent aeration throughout (i.e. similarly sized bubbles distributed substantially homogeneously throughout the food product). It is also important that the acidulant and alkali have the opportunity to be thoroughly mixed and distributed substantially homogeneously throughout the mixed composition so that reactions can continue even as the food product's matrix starts to form and the components become physically isolated from each other. Ideally, the acidulant acidulates at a moderate rate over a period of up to about 20 to 60 minutes (e.g. up to about 23, 30, 40, 50 or 60 minutes) after addition of liquid to the mix (after about 30 minutes it is likely that only a small proportion of the acidulant would still be reacting to cause an increase in the volume of the resultant food product, but some reactions may still be occurring to neutralise the residual acidulant/alkali). Again, the properties of the resultant food product having any given composition can readily be determined simply by observing and tasting the product.

Acidulation would typically commence immediately upon mixing with the liquid, or shortly thereafter (so the matrix has a chance to start forming before gas is produced). In some embodiments, acidulation may continue even after the matrix has been substantially completely formed. For example, in some embodiments, it may be desired for the food product to have an acidic taste (e.g. when the food product is required to have a tart taste, such as that of a lemon sorbet). The rate of acidulation may be consistent throughout this time, or may slow down throughout this time (especially as the reaction of the acidulant(s) and alkali(s) nears completion).

In some embodiments, the acidulant may have inherent properties that result in it acidulating at a defined rate (e.g. they are weak acids). In some embodiments, the acidulant (or indeed, the alkali) may be coated with a coating which dissolves upon exposure to the liquid. The time taken for the coating to dissolve will affect the length of time which the matrix forming agent has to commence formation of the matrix without the evolution of gas from the aerating system. The acidulant and/or the alkali may be coated in this manner using methods known to persons skilled in the art in order to control the period over which aeration is produced.

The proportion and amount of the acidulant(s) in the composition will depend on a number of factors, including the nature of the food product, whether any leftover acidity is desirable (e.g. to impart an acidic flavour) and the degree of aeration required. In some embodiments, the acidulant will comprise between about 0.5 and 12% by weight of the total composition, for example, between about 0.5 and 7%, between about 0.5 and 5%, between about 0.5 and 2.5%, between about 1.5 and 6% or between about 2.5 and 5% by weight of the total composition. In some embodiments, the acidulant will comprise about 0.5, 1.0, 1.5, 2.0, 2.5, 3.0, 3.5, 4.0, 4.5, 5.0, 5.5, 6.0, 6.5, 7%, 7.5%, 8.0%, 8.5%, 9.0%, 9.5%, 10.0%, 10.5%, 11.0%, 11.5% or 12% by weight of the total composition.

The stoichiometric amounts of the acidulant and the alkali in the composition are typically substantially the same so that substantially all of the acidulant and alkali in the composition can react to form the gas during formation of the food product. In some embodiments, however, it may be desirable to have a slight excess of the acidulant or (less likely) a slight excess of the alkali because the leftover acidulant/alkali may impart desirable properties (e.g. a slight tartness, enhanced sweetness or increased shelf-life) to the resultant food product. As many alkalis have a “soapy” taste, however, it is less likely that the composition would contain an excess of alkali.

The composition for forming an aerated ready-to-eat food product also has an alkali which is capable of reacting with the acidulant to form a gas.

Any alkali that is a permitted food grade additive and which will react with the acidulant (i.e. once acidulated) to form a gas may be used. The most suitable alkalis (i.e. sources of aeration) are carbonate or bicarbonate salts, such as potassium and sodium, singly or in admixture. As will be appreciated, carbonate or bicarbonate salts react with acids to form carbon dioxide, a common gas used for aerating food products. Typically, the alkali used in the present invention will be highly soluble such that it can rapidly dissolve and become homogeneously dispersed in the liquid.

The proportion of the alkali(s) in the composition will depend on a number of factors, including the nature of the food product, the degree of aeration required, the degree of overrun and lightness required and the amount of acidulant in the composition. In some embodiments, the alkali will comprise between about 0.3 and 6.5% by weight of the total composition, for example, between about 0.3 and 4%, between about 0.3 and 3%, between about 0.5 and 2.5% or between about 1 and 2% by weight of the total composition. In some embodiments, the alkali will comprise about 0.3, 0.5, 1.0, 1.5, 2.0, 2.5, 3.0, 3.5, 4%, 4.5%, 5%, 5.5%, 6% or 6.5% by weight of the total composition.

### Additional Components

The composition for forming the aerated ready-to-eat food product may also include a number of additional components, each of which may impart desirable properties to the resultant food product. These additional components will be described below.

The composition for forming the aerated ready-to-eat food product may also include a sweetener in order to sweeten the food product and to effect textual properties and functions, especially in ready-to-eat frozen food products (e.g. frozen dessert products). Any suitable food-grade sweetener may be used, although the sweetener would typically be one that can be provided in a dry powder form, consistent with other components of the composition. Suitable sweeteners include sucrose, glucose, fructose (and other sugars), dried honey as well as dry maltose preparations and polydextrose. Non-nutritive sweeteners (e.g. stevia, cyclamate, maltol, thaumatins, aspartame, sucralose or saccharine) may also be used, especially in ready-to-eat chilled or ambient sweet products, savoury formats or dietetic products. In some embodiments, combinations of sweeteners may be used.

The amount of sweetener used will influence the sweetness of the resultant food product and therefore depend on factors such as whether the food product is sweet or savoury, intended to be a light or diet food product, etc. The amount and kind of sweetener can also influence the texture and mouthfeel of the resultant food product and, in embodiments where the ready-to-eat food product is intended to be frozen, the presence of sugars (and their relative proportion) will influence the ice crystal size, the coolness sensation when tasted (as well as other organoleptic properties) and the firmness of the frozen product when scooped for servings. The amount of sweetener used can be determined by a person skilled in the art based on these factors, but typically, the sweetener (if used) would be up to about 60% (e.g. about 0.1%, 1%, 5%, 10%, 20%, 30%, 40%, 50% or 60%) by weight of the total composition.

The composition for forming the aerated ready-to-eat food product may also include a source of protein. A source of protein adds nutritional value to the resultant food product and can also provide desirable tastes and textures to the food product. For example, protein may provide body and mouthfeel and, in some circumstances, provide a curdy mouthfeel which can be quite pleasing.

Any source of protein that is an allowable food additive and which will not deleteriously affect the aerated properties of the food product may be used. The protein would typically be provided in a dry powder form, consistent with other components of the composition. In some embodiments, the source of protein may be selected from the group consisting of: a dry dairy solids preparation, a dry preparation of non-dairy protein and combinations thereof. Suitable dry dairy solid preparations may, for example, be selected from the group consisting of: full-fat milk powder, skim milk (non-fat) powder, whey powder, whey protein, whey protein concentrate, whey protein isolate, caseinate preparations, cheese powders, sour cream powders, yogurt powders and combinations thereof. Suitable dry preparations of non-dairy protein may, for example, be selected from the group consisting of: soy protein concentrate, soy protein isolate, full-fat soy flour, potato protein isolate, pea protein isolate, meat stock powders, coconut milk powders, vegetable powders, egg powder, yeast protein extracts, bacterial protein extracts, fungal protein powders, meat powders (e.g. dehydrated meat powders) and combinations thereof.

In some embodiments, non-dry sources of protein may be included in the composition of the present invention. For example, the source of protein may be a shelf-stable liquid preparation (e.g. UHT or pasteurised milk), other shelf-stable protein sources such as legumes or pulses or a shelf-stable meat or fish preparation (e.g. a shelf-stable protein source such as salmon or tuna). As noted above, such “wet” components would ideally not be stored with other “dry” components of the present invention, but should be admixed with other components before use.

In some embodiments, the source of protein may comprise a shelf-stable legume, pulse, algal, microbial, dairy, seed, egg, meat or fish preparation, which may impart a desirable taste or protein content to the resultant food product.

In some embodiments, different types of proteins can be included in the composition that impart desirable nutrition attributes such as high levels of essential amino acid content, which may be important in special dietary needs. Suitable concentrated protein preparations may include for example whey protein concentrates and isolates, whole soy flour, soy protein concentrates and isolates. Pea protein concentrates and isolates and egg proteins may also be included, as long as they do not interfere with the desired organoleptic properties or function properties of the resultant food products.

When present, the amount of protein in the composition should not be so low that its presence cannot be detected by a consumer, nor so high that it becomes overpowering or otherwise adversely affects the food product. Suitable amounts of protein for a particular food product can be determined by a person skilled in the art based on the teachings contained herein and using routine trials and experimentation. However, in some embodiments, the composition may include between about 5% to about 45% (e.g. about 5%, 10%, 15%, 20%, 25%, 30%, 35%, 40% or 45%, by weight of the total composition) of the source of protein.

Use of full-fat milk powder provides a source of fat to the resultant food product. Likewise a full-fat soy flour will have the same effect. Additional fats (e.g. vegetable fats such as hydrogenated sunflower and cotton seed oils, animal fats such as dry preparations of dairy fats, and nut fats such as coconut and palm kernel) may be provided if required by addition of powdered fat preparations as are available from suppliers of food ingredients. Suitable amounts of fats for a particular food product can be determined by a person skilled in the art based on the teachings contained herein and using routine trials and experimentation. However, in some embodiments, the composition may include between about 3% to about 25% (e.g. about 3%, 7%, 10%, 15%, 18%, 20%, 22% or 25%, by weight of the total composition) of the fat.

In some embodiments, it may be desirable to provide a low fat (or no fat) aerated ready-to-eat food product. In such embodiments, equivalent low/no fat substances may be used.

The composition for forming the aerated ready-to-eat food product may also include an emulsifier. An emulsifier may help to stabilise fat globules (when present) and the aqueous phase in the composition after the liquid is added, may prevent syneresis, help to form and stabilise opacity (the opacity can be increased due to the emulsifiers stabilising the fat droplets in micro dimensions), may impart a smooth mouthfeel and may also assist in aeration of the food product.

Any suitable food-grade emulsifier may be used, provided its presence in the composition/mixture does not deleteriously affect the food product. The emulsifier would typically be provided in a dry powder form, consistent with other components of the composition. Suitable emulsifying agents include dry whole egg powder, dry egg yolk powder, polyglycerol esters of fatty acids, monoglycerides, sucrose esters of fatty acids, lecithin and soy flours. In some embodiments, combinations of emulsifiers may be used. The amount of emulsifier in the composition will depend on factors such as the amount of fat present in the composition and the amount of liquid to be added, and can be determined by a person skilled in the art for any particular food product. Typically, however, the emulsifier (if present) would be about 0.25% to about 6% (e.g. about 0.5%, 1%, 2%, 3%, 4%, 5% or 6%) by weight of the total dry composition.

The composition for forming the aerated ready-to-eat food product may also include a flavourant in order to impart a particular flavour to the food product.

Any suitable food-grade flavourant suitable for this purpose may be used. The flavourant would typically be provided in a dry powder form, consistent with other components of the composition. Suitable flavourants include vanilla, chocolate, strawberry, caramel, butterscotch, nut flavours, fruit powders, vegetable powders, cheese powders, powdered fats, salts, herbs, spices, flavour enhancers, savoury stock powders, hydrolysates, meat powders and extracts. In some embodiments, combinations of flavourants may be used. The amount of flavourant in the composition will depend on the particular food product and can be determined by a person skilled in the art. However, in some embodiments, the amount of flavourant in the composition may be between about 0.1% to about 15% (e.g. about 0.1%, 0.3%, 0.5%, 1%, 2%, 4%, 6%, 8%, 10%, 12%, 14% or 15%) by weight of the total dry composition.

The composition for forming the aerated ready-to-eat food product may also include a colourant in order to provide the food product with a desirable colour. Any suitable food-grade colourant may be used, although the colourant would typically be one that can be provided in a dry powder form, consistent with other components of the composition. Suitable colourants include natural colourants or their extracts such as caramel, carotenoids, xanthophylls, anthocyanins, curcumin, lycopene, riboflavin, zeaxanthan, amaranth, chlorophyll or any of a range of permitted artificial colourants. It is to be noted that some colourants are also flavourants and may therefore provide a dual function in the composition.

In some embodiments, the composition may further comprise additional nutrients, vitamins, minerals, dried microbial cultures and the like, with their beneficial properties being imparted to the resultant food product.

In some embodiments, a variety of further components such as chopped nuts, dried or candied fruit, herbs, spices or garnishes may also be included in the composition (either intimately mixed with the other components or provided in a separate package within the container). Alternatively, frozen fruits, prepared meats and other components may be added to provide a food product having particulates either at the same time as the admixture of liquid and dry-mix and before the mixing step or after the mixing step but before the matrix formation is completed.

### Method for Forming the Aerated Ready-to-Eat Food Product

The fourth aspect of the present invention provides a method for forming an aerated ready-to-eat food product. The method comprises admixing a liquid and a mixture comprising a matrix forming system (which, upon exposure to the liquid, forms a matrix defining a structure of the food product) and an aerating system comprising an acidulant (which, upon exposure to the liquid, acidulates at a rate that is similar to a rate at which the matrix is formed) and an alkali capable of reacting with the acidulant to form an aerating gas. The resultant mixture is then quiescently maintained in ambient environmental conditions whilst the food product forms.

Typically, a user would measure out a predefined weight or volume of the composition of the present invention and add this to a container. The user would then measure out a predefined weight or volume of the liquid (e.g. a cold liquid, for example one just removed from a refrigerator) and add this to the composition in the container, preferably with mixing (e.g. with a blender or hand whisk) for only a few minutes (e.g. for about 1 to 2 minutes) in order to ensure even dispersal of all of the powder components throughout the liquid and the forming matrix. Alternatively, the dry mix could be added to the measured liquid and then mixed as described above.

Once mixed, the mixture may be left to stand quiescently at ambient environmental conditions while the matrix forming and aeration processes simultaneously occur to form the ready-to-eat aerated food product. The time taken for the reactions to process to completion will depend on the temperature, type of food product, components, etc., but quiescently maintaining the food product at ambient environmental conditions (e.g. room temperature) for between about 1 minute and about 60 minutes should be sufficient to form the aerated ready-to-eat food product. In embodiments where the food product is intended to be served cold, it may be stored at a temperature of between about 2° C. and 4° C. after the full increase in volume of the food product has occurred (or the increase in volume is well underway), but this may require times longer than an hour (e.g. overnight or longer) for the product to completely form. In embodiments where the food product is intended to be served frozen, it may be quiescently maintained at ambient environmental conditions until the full increase in volume has taken place, and then stored at a temperature of between about −10° C. and −20° C. for about 6 hours (e.g. overnight) or longer for subsequent consumption. It is important to ensure that the food product is substantially formed before putting it into the freezer, lest portions of the liquid freeze before its formation was completed.

The inventors have found that smaller ice crystals tend to form in frozen food products of the present invention when mixtures in which the matrix forming and aeration reactions are substantially complete are placed into a freezer, probably due to the partially-aerated nature of the product, the lack of available free water and due to the products typically being produced in small amounts (which tend to freeze quickly and result in smaller ice crystals). As would be appreciated, food products containing large ice crystals tend to have an “icy” mouth feel, which may not be compatible with a food product intended to have a mousse-type consistency.

An example of the method of the present invention being used to form a frozen dessert product will now be described. When taken from the freezer, the frozen dessert product is essentially smooth in texture and non-icy, comparable to commercially manufactured frozen desserts. The frozen dessert product may be easily scooped direct from the freezer onto a bowl or cone. The inventors have surprisingly found that if the frozen dessert product is left to warm it retains its scooped shape and does not appear to melt, even after it is totally thawed and warmed to ambient temperature. This “non-melt” characteristic is very advantageous for products intended to be eaten from a cone, in warm climates or served after removal from frozen storage (e.g. as a mousse-like thawed dessert, which is served at chilled or even room temperature).

In embodiments where a frozen dessert product is to be formed, it may be beneficial for the admixture of dry-mix and liquid to be performed by the ultimate user in the container in which the food product is to be frozen. However it is also acceptable for mixing to be done in a bowl from which the final mix is promptly transferred to the container in which the food product is to be frozen. Mixing of the liquid and dry-mix should be rapid—1 to 2 minutes—which is sufficient for all the components to achieve solubility or substantially uniform dispersion. The mixture in the freezing container should occupy no more than half the capacity to allow for aeration and increased product volume. A loose lid is applied and the mixture is allowed to rest quiescently at room temperature for a short period of time, typically about 10 to about 30 minutes, after which the food product is ready to consume. The loosely lidded container may also be rested in the refrigerator for a slightly longer period in order to produce a chilled form of the food product ready for consumption. During this rest time the aerating system will produce a steady increase in the volume of the food product, similar to the overrun which occurs during the manufacture of ice creams (although these properties are imparted to the ice cream by vigorous mechanical mixing). Alternatively, at the end of the rest period, the lid may be firmly affixed and the product placed in the freezer for several hours or overnight, after which a frozen form of the food product is ready to consume.

As noted above, the inventors have discovered that the present invention can result in aerated ready-to-eat dessert products having surprising and unexpected properties. In particular, the inventors have found that compositions in accordance with embodiments of the present invention can produce frozen desserts of many types in the hands of the user, including frozen desserts similar to but different from ice creams, sorbets, gelatos and the like.

The frozen desserts prepared in accordance with the invention may be quiescently (i.e. without any agitation, stirring or mixing during freezing) prepared and then frozen by the user in the freezer section of a domestic refrigerator/freezer. This is in contrast to industrial frozen desserts which are frozen under strong agitation or churning, often with air incorporation using pumps to achieve lightness, smoothness and overrun. Likewise, it is in contrast to methods used in some homes which possess a bench-type mechanical ice cream freezer which agitates the mixture during freezing.

The inventors have surprisingly found that even though the food product is quiescently formed and subsequently frozen, it can produce a smooth-textured frozen dessert, essentially non-icy, and possessing a self-generated lightness, overrun or reduced bulk density similar to commercial ice cream-type products. Most surprisingly, however, frozen food products produced in accordance with the present invention have been found to have the unique property of remaining in essentially the same shape as that scooped from the frozen product, even when left to thaw, for example in a bowl or in a cone. Thus, on thawing/warming, the food product does not dribble or become liquid. As will be appreciated, this is very different from commercial or home-made frozen desserts, which melt and dribble and lose their shape and texture as they change from a frozen to a thawed state.

The inventors have also found that the dessert product may be re-frozen without any substantial change in the product volume or textural quality. Furthermore, the frozen product prepared from the dry mix of the invention may be readily scooped or sliced with ease immediately after it is removed from the freezer (e.g. while it is at −10° C. to −18° C.).

The composition of the present invention is ideal for use in a home situation, especially when it is shelf-stable (which, as discussed, is the case in the vast majority of embodiments). However, it may also be used in commercial/food service kitchens, restaurants and cafes, hospitals and other institutional situations whereby chefs can prepare their own food products (e.g. frozen desserts). The frozen food products of the invention, for example, are especially useful in mass-feeding situations where conventional ice cream-type products are served because of the non-melting character of the frozen food product of the invention. Additionally, in the field, where access to chilling or freezing facilities may be limited (or completely unavailable), easy to prepare aerated food products can be produced in both sweet and savoury formats from shelf-stable and easy to carry supplies.

As discussed herein, there is a considerable economic advantage accruing from energy savings for frozen dessert products in accordance with the present invention. However, many embodiments also provide advantages such as convenience and novelty value for food products in accordance with the present invention.

For example, very light textured chilled or non-chilled food products can be produced in accordance with the present invention without the need for prolonged whipping, as is the case for classical desserts such as mousses, Bavarian creams and the like (which depend for their aeration and lightness on incorporation of whipped cream or stiffly beaten egg white, as well as emulsifies and stabilisers). In contrast, highly acceptable food products in accordance with the present invention can be produced with as little as 2 minutes of time from the operator, and which can be eaten within 20-30 minutes of preparation.

Food products in accordance with embodiments of the present invention may be of a dessert type or more of a savoury type, in which sweeteners are used minimally or not at all. The dry mixes used to produce savoury food products in accordance with embodiments of the present invention may, for example, contain cheese powders of different types, spices and herbs and other dry ingredients. Furthermore, on admixture of the components, additional savoury ingredients like smoked goods, canned meats, fish and vegetables can be added to form savoury dips and spreads. The inventors have found that such products can now be formed having low fat (e.g. less than 3% fat), low calorie and non-acid compositions, unlike the bulk of present bottled, canned and refrigerated dips and spreads on the market.

Alternately, for dessert applications, the dry mixes used to produce sweet food products in accordance with embodiments of the present invention will be of a sweet nature and comprise any variety of flavours, again achieving lightness of texture and mouthfeel in accordance with this invention. The inventors have also found that low fat (e.g. less than 3% fat) and reduced calorie ice cream-like (and other) dessert products can be produced without resorting to inferior texture products that are common in the market at present.

Specific advantages of frozen dessert products in accordance with embodiments of the present invention over existing frozen dessert products, such as ice creams, gelatos and the like, include:
For the home consumer, embodiments of the present invention represent an alternative to the hazard of buying ice cream and the like in a retail outlet and then transporting the frozen product back home. It is well known that partial warming and thawing then refreezing of conventional ice creams has a serious negative effect on their quality (especially during summer conditions).
Embodiments of the present invention may represent a major energy saving as compared to conventional ice cream-type products. Conventional ice cream manufacture involves large amounts of energy and specialised expensive equipment in the handling of perishable raw materials, their blending, homogenising, pasteurisation, chilling and refrigerated holding (tempering), plus the energy for final churning/aeration/freezing, hardening and storage. Then there is the cost of freezer delivery of finished products to warehouses and to retail outlets such as supermarkets and the like, as well as the energy required for freezer storage in retail cabinets.
Embodiments of the compositions of the present invention may be advantageous for the retailer since they are shelf-stable and may be displayed on the regular shelves. In contrast, ice creams and other existing frozen desserts require the retailer to provide expensive freezer display cabinets, along with costly supply of power to maintain stock in a frozen condition. In contrast, for manufacture of the products of this invention, the ingredients come direct from suppliers as dry ingredients, are blended according to specified formulations, packaged then distributed at ambient temperature to retailer outlets where they are displayed on shelves without the need for refrigerated cabinets. The only refrigeration required down the whole chain is when the final prepared mix is placed in the freezer. Once frozen, the products of this invention are more stable to freeze-thaw damage.

### EXAMPLES

Examples of specific embodiments in accordance with the present invention will now be described.

### Example 1

A dry mix in accordance with an embodiment of the invention had the following composition:

| | Dry Mix % |
|---|---|
| Pre-gelatinised waxy maize starch | 9.5 |
| Sucrose | 40.6 |
| Glucose monohydrate | 7.2 |
| Dry maltodextrin powder | 7.2 |
| Full-fat milk powder | 23.9 |
| Xanthan gum powder | 0.6 |
| Powdered whole dry egg | 3.4 |
| Vanilla flavour powder | 1.2 |
| Glucono-delta lactone powder | 4.8 |
| Sodium bicarbonate | 1.6 |

All the above dry ingredients were mixed then passed through a fine sieve twice to ensure uniform mixing.

To make about 1 Litre of frozen dessert, 220 g of dry mix was added to 300 ml cold full-fat milk in a tared 1 litre container and whisked very thoroughly until all the dry mix was well incorporated and dissolved or dispersed. Mixing time was 1-2 minutes. The container was about half-full. The weight of the contents was noted.

The container was loosely covered and allowed to stand quiescently for 30 minutes on the bench. The volume of the mix increased to almost fill the container.

A firmly fitting lid was affixed to the container, which was then placed in the freezer section of a refrigerator-freezer. The next day the volume of the frozen dessert was measured. The bulk density was 0.53 g/ml.

The frozen dessert was easily scooped into a bowl or cone. It had a creamy mouth-feel and was essentially non-icy.

When a serving was left to warm to room temperature, the dessert retained the form it had when scooped from the container, even to the ripples on the surface of the scoop. In this semi-frozen or thawed condition, the product closely resembled a mousse-type dessert. It did not melt or dribble, even in a cone.

The rest of the frozen dessert was covered and returned to the freezer compartment for several months. The quality of the frozen dessert was checked periodically. The qualities described above were retained.

### Example 2

This example of a dry mix for use in making a refrigerated (not frozen) dessert in accordance with an embodiment of the invention has the following composition.

| | Dry Mix % |
|---|---|
| Pre-gelatinised dry tapioca starch | 9 |
| Sucrose | 45 |
| Glucose monohydrate | 10 |
| Xanthan gum | 0.6 |
| Gelatin | 3.0 |
| Vanilla, dry powdered | 1.5 |
| Full Fat Milk Powder | 24 |
| Anhydrous monocalcium phosphate | 4.2 |
| Sodium bicarbonate | 2.7 |

The procedure for preparing the dry mix was as described in Example 1.

To make four servings of refrigerated dessert, 200 g of dry mix was added to 400 g ice-cold full cream milk and whisked thoroughly for 2 minutes. The mixture was then promptly divided amongst 4 bowls so that each bowl was about half-full. Each bowl was loosely covered with film and placed in the refrigerator for about 2 hours. The volume of the dessert almost doubled, producing a light-textured foamy and delicious eating sensation. The desserts were kept covered and stored at refrigerator temperature for 1 week without any detrimental changes to the product.

### Example 3

This example describes the formation of a ready-to-eat chocolate flavoured food product in accordance with an embodiment of the invention with no refrigeration or freezing. The dry mix has the following composition.

| | Dry Mix % |
|---|---|
| Pre-gelatinised dry tapioca starch | 7.5 |
| Sucrose | 50 |
| Glucose monohydrate | 7.5 |
| Xanthan gum | 0.6 |
| Gelatin | 3.0 |
| Vanilla, dry powdered | 1.3 |
| Full Fat Milk Powder | 17.1 |
| Cocoa Powder | 7.6 |
| Anhydrous monocalcium phosphate | 3.4 |
| Sodium bicarbonate | 2.0 |

The procedure for preparing the dry mix was as described in Example 1.

The mixture was portioned into serving bowls uncovered and left at room temperature for a total of 30-60 minutes before serving. The volume of dessert had almost doubled, producing a light textured foamy and mousse-like eating sensation with a delicious chocolate flavour.

### Example 4

This example describes a flavoured unsweetened dry mix composition in accordance with an embodiment of the invention for the preparation of ready-to-eat savoury cream cheese and smoked salmon dip or spread applications that may be consumed directly or stored refrigerated for later use.

| | Dry Mix % |
|---|---|
| Pre-gelatinised dry maize starch | 34.97 |
| Full Cream Milk Powder | 34.97 |
| Xanthan gum | 1.75 |
| Lecithin powder | 6.99 |
| Cream Cheese Powder | 1.40 |
| Sour Cream Powder | 1.40 |
| Salt | 2.5 |
| Pepper | 0.5 |
| Yeast extract | 0.5 |
| Anhydrous monocalcium phosphate | 9.50 |
| Sodium bicarbonate | 5.52 |

All the above dry ingredients were mixed then passed through a fine sieve twice to ensure uniform mixing of the dry mix product.

To make about 1 Litre of savoury dip or spread, 110 g of dry mix was added to 600 ml full-fat cold milk and 100 g of fresh commercial chopped smoked salmon in a tared 1 litre container and the ingredients blended very thoroughly until all the dry mix was well incorporated and dissolved or dispersed. Mixing time was 1-2 minutes. The container was about half-full. The initial bulk density of the blend was 1.03 g/ml.

The container was loosely covered and allowed to stand quiescently for 60 minutes on the bench. The volume of the mix increased to almost fill the container and the final bulk density was 0.79 g/ml. The product displayed a light and aerated mousse appearance with a multitude of fine bubbles throughout the matrix. The texture was creamy and light, easily scooped with a cracker and was spreadable onto toast. The resultant product had a pleasant salmon and cream cheese mousse flavour and texture with a characteristic salmon colour.

A firmly fitting lid was affixed to the container which was then placed in a refrigerator. After 3 days the product essentially retained its original volume and eating characteristics.

When a serving was left to warm to room temperature, the salmon mousse retained its physical form without any syneresis.

### Example 5

This example describes an unsweetened dry mix composition in accordance with an embodiment of the invention for the preparation of ready-to-eat savoury tuna dip or spread applications that may be consumed directly or stored refrigerated for later use.

| | Dry Mix % |
|---|---|
| Pre-gelatinised dry maize starch | 39.43 |
| Full Cream Milk Powder | 31.55 |
| Xanthan gum | 1.97 |
| Lecithin | 7.89 |
| Salt | 3.00 |
| Pepper | 0.94 |
| Anhydrous monocalcium phosphate | 9.62 |
| Sodium bicarbonate | 5.60 |

All the above dry ingredients were mixed then passed through a fine sieve twice to ensure uniform mixing of the dry mix product.

To make about 1 Litre of savoury tuna dip or spread, 110 g of dry mix was added to 600 ml full-fat cold milk plus 100 g drained canned tuna in a tared 1 litre container and the ingredients blended very thoroughly until all the dry mix was well incorporated and dissolved or dispersed. Mixing time was 1-2 minutes. The container was about half-full. The initial bulk density of the blend was 1.01 g/ml.

The container was loosely covered and allowed to stand quiescently for 30 minutes on the bench. The volume of the mix increased to almost fill the container and the final bulk density was 0.79 g/ml. The product displayed a light and aerated mousse appearance with a multitude of fine bubbles throughout the matrix. The texture was creamy and light, easily scooped with a cracker and was spreadable onto toast. The resultant product had a pleasant tuna mousse flavour and texture with a characteristic tuna colour.

A firmly fitting lid was affixed to the container which was then placed in a refrigerator. After 3 days the product bulk density was essentially unchanged as were its eating characteristics. The product was stored in the freezer 1 month. When it was removed and left to warm to room temperature, the tuna mousse retained its physical form without any syneresis.

### Example 6

This example describes a mushroom flavoured unsweetened dry mix product applicable for the preparation of a ready-to-eat savoury dip or spread applications that may be consumed directly or stored refrigerated.

| | Dry Mix % |
|---|---|
| Pre-gelatinised dry maize starch | 40.81 |
| Full Cream Milk Powder | 15.18 |
| Xanthan gum | 2.14 |
| Lecithin powder | 8.56 |
| Salt | 3.00 |
| Pepper | 0.94 |
| Mushroom Powder | 4.28 |
| Dried Diced Mushroom | 8.56 |
| Anhydrous monocalcium phosphate | 10.45 |
| Sodium bicarbonate | 6.08 |

All the above dry powder ingredients were mixed then passed through a fine sieve twice to ensure uniform mixing dry mix product, with the particulates being blended in last.

To make about 1 Litre of savoury mushroom dip or spread, 110 g of dry mix was added to 300 ml full-fat cold milk and 300 g single strength commercial canned mushroom soup in a tared 1 litre container and the ingredients blended very thoroughly until all the dry mix was well incorporated and dissolved or dispersed. Mixing time was 1-2 minutes. The container was about half-full. The initial bulk density of the blend was 0.72 g/ml.

The container was loosely covered and allowed to stand quiescently for 60 minutes on the bench. The volume of the mix increased to almost fill the container and the final bulk density was 0.63 g/ml. The product displayed a light and aerated mousse appearance with a multitude of fine bubbles throughout the matrix. The texture was creamy and light, easily scooped with a cracker and was spreadable onto toast. The resultant product had a pleasant rich mushroom mousse flavour and texture with a characteristic mushroom colour.

A firmly fitting lid was affixed to the container which was then placed in a refrigerator. After 3 days in the refrigerator, the product substantially retained its volume and eating characteristics. Another sample was kept in the freezer for 3 months and, on warming to room temperature, it was ready to eat as a dip or spread. When a serving was left to warm to room temperature, the mushroom mousse retained its physical form without any syneresis.

### Example 7

This example describes a vegetarian style dry mix product applicable for the preparation of a ready-to-eat sweet frozen, refrigerated or room temperature-ready applications.

| | Dry Mix (%) |
|---|---|
| Pre-gelatinised dry maize starch | 8.60 |
| Full Fat Soy Powder (enzyme inactive) | 14.35 |
| Xanthan gum | 0.72 |
| Lecithin powder | 2.87 |
| Sugar | 57.39 |
| Dextrose Monohydrate | 8.61 |
| Vanilla | 1.92 |
| Anhydrous monocalcium phosphate | 3.50 |
| Sodium bicarbonate | 2.04 |

All the above dry ingredients were mixed then passed through a fine sieve twice to ensure uniform mixing dry mix product. To make about 1 Litre of frozen dessert, 110 g of dry mix was added to 140 ml full-fat coconut milk and 140 ml of cold water in a tared 1 litre container and the ingredients blended very thoroughly until all the dry mix was well incorporated and dissolved or dispersed. Mixing time was 1-2 minutes. The container was about half-full.

The container was loosely covered and allowed to stand quiescently for 30 minutes on the bench. The volume of the mix increased to almost fill the container and the final bulk density was 0.64 g/ml. The product displayed a light and aerated creamy white foam appearance with a multitude of fine bubbles throughout the matrix.

A firmly fitting lid was affixed to the container which was then placed in a freezer. After 7 days in the freezer the bulk density of the products was essentially unchanged. The frozen product was easy to scoop (as in example 1), and had a clean mouthfeel and rich sweet flavour of coconut and vanilla. A second preparation was made and instead stored refrigerated for 3 days, after which the product had a light mousse texture and appearance. When a serving of either frozen or chilled product was left to warm to room temperature, the product retained the physical form without any syneresis or melting.

It will be understood to persons skilled in the art of the invention that many modifications may be made without departing from the spirit and scope of the invention.

It is to be understood that any prior art publication referred to herein does not constitute an admission that the publication forms part of the common general knowledge in the art.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A composition for forming an aerated ready-to-eat food product quiescently and in ambient environmental conditions, the composition comprising:
a matrix forming system which is capable of forming a matrix defining a structure of the food product at ambient environmental conditions upon exposure to a liquid; and
an aerating system comprising:
an acidulant which is capable of acidulating at ambient environmental conditions at a rate that is similar to a rate at which the matrix is formed upon exposure to a liquid; and
an alkali which is capable of reacting with the acidulant to form an aerating gas.

2. The composition of claim 1, wherein the matrix forming system comprises a pre-gelatinised starch, a pre-gelatinised starch-containing flour or a mixture thereof.

3. The composition of claim 1, wherein the matrix forming system further comprises one or more stabilisers.

4. The composition of claim 1, wherein the matrix forming system further comprises one or more moisture holding agents.

5. The composition of claim 1, wherein the acidulant comprises an acid, an acid salt or an acid lactone that acidulates upon exposure to the liquid.

6. The composition of claim 1, wherein the acidulant acidulates over a period of up to about 60 minutes after exposure to the liquid.

7. The composition of claim 1, wherein the acidulant is selected from one or more of: cream of tartar, acid calcium phosphates, glucono delta lactone, tartaric acid, adipic acid, fumaric acid, malic acid and citric acid.

8. The composition of claim 1, wherein the alkali comprises a carbonate or bicarbonate salt.

9. The composition of claim 1, wherein the acidulant or alkali is coated with a coating which dissolves upon exposure to the liquid.

10. The composition of claim 1, wherein the composition comprises between about 5 and 90% (by weight of the total composition) of the matrix forming system; between about 0.5 and 12% of the acidulant; and between about 0.3 and 6.5% of the alkali.

11. The composition of claim 1, further comprising one or more of the following: a sweetener, a source of protein, a source of fat, an emulsifier, a flavourant and a colourant.

12. The composition of claim 1, wherein the composition comprises a mixture of components in amounts sufficient to form the aerated ready-to-eat food product upon addition of a predefined weight or volume of liquid.

13. A composition comprising:
a matrix forming system; and
an aerating system comprising an acidulant and an alkali,
whereby, in ambient environmental conditions and upon exposure to a liquid, the matrix forming system forms a matrix defining a structure of the food product, and the acidulant acidulates at a rate that is similar to a rate at which the matrix is formed and progressively reacts with the alkali to form an aerating gas.

14. An aerated ready-to-eat food product which is produced by mixing the composition of claim 1 with a liquid.

15. A method for forming an aerated ready-to-eat food product, the method comprising:
admixing a liquid with a mixture comprising:
a matrix forming system which, upon exposure to the liquid, forms a matrix defining a structure of the food product; and
an aerating system comprising an acidulant which, upon exposure to the liquid, acidulates at a rate that is similar to a rate at which the matrix is formed, and an alkali capable of reacting with the acidulant to form an aerating gas, and
quiescently maintaining a resultant mixture in ambient environmental conditions.

16. The method of claim 15, wherein the liquid and mixture is admixed for between about 1 and 2 minutes.

17. The method of claim 15, wherein the resultant mixture is quiescently maintained at ambient environmental conditions for about 10 to about 60 minutes.

18. The method of claim 15, further comprising quiescently storing the food product at a temperature of between about −10 and −20° C.

19. The method of claim 1, wherein the liquid and a mixture comprising the composition of any one of claims 1 to 13 are admixed.

20. The method of claim 15, wherein the liquid is selected from the group consisting of: full-cream milk, low fat milk, skim milk, flavoured milk, soy milk, nut milk, rice milk, oat milk, dairy cream, vegetable stock, vegetable juice, meat stock, fish stock, coconut water, coconut milk, coconut cream, water and combinations thereof.

21. (canceled)
